(19) United States
(12) Patent Application Publication
(10) Pub. No.: US 2009/0268330 A1
(43) Pub. Date: Oct. 29, 2009

(54) METHOD AND APPARATUS ESTIMATING TOUCH-DOWN APPROACH FLYING HEIGHT FOR MAGNETIC HEAD OF DISK DRIVE

(75) Inventors: Joo-hyun LEE, Anyang-si (KR); Jae-jin LEE, Seoul (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/430,170

(22) Filed: Apr. 27, 2009

(30) Foreign Application Priority Data
Apr. 28, 2008 (KR) 10-2008-0039345

(51) Int. Cl. G11B 27/36; G11B 21/02

(52) U.S. Cl. 360/31; 360/75; G9B/27.052

(57) ABSTRACT

A method and apparatus for controlling flying height for the read/write head of a HDD. The method uses the flying status of the head immediately before the head touches down on the disk to provide such control.

### CROSS-REFERENCE TO RELATED APPLICATIONS

This application claims the benefit of Korean Patent Application No. 10-2008-0039345 filed on Apr. 28, 2008, the subject matter of which is hereby incorporated by reference.

### BACKGROUND

The invention relates to a method and apparatus for controlling the read/write head of a disk drive. More particularly, the invention relates to a method and apparatus for controlling the flying height for the head by detecting a flying status immediately before the head touches down on a disk.

Hard disk drives (HDDs) are commonly used as data storage devices for computer systems. HDDs write data to a disk and/or reproduce data written on the disk using a magnetic read/write head. As HDDs trend towards higher data storage capacity and more compact physical sizes, the resulting data bit recording density in a tangential direction (as commonly measured in bits-per-inch (BPI)) and the resulting track density in a radial direction (as commonly measured in tracks-per-inch (TPI)) increases. Such increases require the implementation and operation of ever more accurate and delicate mechanisms with HDDs.

The so-called “flying height” of a magnetic head is a measure of the clearance between the magnetic head and a disk. Flying height is one system characteristic that defined the overall read/write performance of a HDD. If the flying height of a magnetic head can be reduced the read/write performance of the HDD can be improved. However, reduced flying height also increases the possibility of a collision between the magnetic head and the surface of the disk as induced by a mechanical disturbance or shock.

### SUMMARY

Embodiments of the inventive concept provide a method of estimating a touch-down approach flying height by detecting a flying status for a magnetic head immediately before the magnetic head touches down on a disk.

In one embodiment, the inventive concept provides a method of estimating a touch-down approach flying height, the method comprising; writing information regarding a test pattern on a disk, reproducing a test pattern signal in an area in which the information regarding the test pattern is written while changing a value of a parameter used to control a flying height of a magnetic head, measuring a first power value in a first relatively narrow frequency band including a frequency component such that a distortion occurrence predicts an approaching touch-down, and a second power value in a relatively wide second frequency band including the first frequency band, determining if the first power value compared to the second power value satisfies a critical condition, and if the first power value compared to the second power value satisfies the critical condition, determining that the magnetic head has reached the touch-down approach flying height.

In another embodiment, the inventive concept provides an apparatus for estimating a touch-down approach flying height, the apparatus comprising; a filtering unit filtering and outputting a signal in a first relatively narrow frequency band including a frequency component in which a distortion occurrence is predicted when a touch-down is approached, and a signal in a second relatively wide frequency band including the first frequency band by inputting a test signal reproduced from a disk having information regarding a test pattern written thereon while controlling a flying height of a magnetic head, a power calculating unit calculating a first power value in relation to the signal in the first frequency band and a second power value related to the signal in the second frequency band, a dividing unit calculating a dividing value obtained by dividing the first power value by the second power value, and a comparing unit comparing the dividing value and a first reference value, and if the dividing value exceeds the first reference value, generating a signal indicating that the magnetic head has reached the touch-down approach flying height.

In another embodiment, the inventive concept provides an apparatus for estimating a touch-down approaching flying height, the apparatus comprising; a filtering unit selectively filtering a read data signal and outputting either a first signal in a first, narrow-band, frequency band including a frequency component corresponding to a predicted distortion occurrence related to an approaching touch-down, or a second signal in a second, wide-band, frequency band including the first, narrow-band, frequency band, wherein the read data signal is derived by reproducing data stored on a disk and including test pattern information while controlling a flying height of a magnetic head associated with the disk, a power calculating unit calculating a first power value in relation to the first signal or a second power value in relation to the second signal, and a comparing unit comparing the first power value and a reference value determined in relation to the second power value as calculated during a normal operating status for the magnetic head wherein the touch-down approaching flying height is not reached, and upon determining that the first power value exceeds the reference value, generating a signal indicating that the magnetic head has reached the touch-down approaching flying height.

In yet another embodiment, the inventive concept provides a disk drive comprising; a disk storing information, a magnetic head including a magnetic read element detecting a magnetic field on the disk and a magnetic write element magnetizing the disk, a structure generating an air bearing between a surface of the disk and the magnetic head, and a heater heating the magnetic head to generate the air bearing, a touch-down approach position determining unit determining whether a flying height of the magnetic head has reached a touch-down approach position over the disk based on a power value associated with at least one frequency band related to a test signal reproduced from information regarding a test pattern recorded on the disk, and a controller calculating a magnetic head flying height profile indicating a change in clearance between the magnetic head and the disk in relation to a change in power supplied to the heater and a determination result received from the touch-down approach position determining unit changing the power supplied to the heater, and determining an amount of power supplied to the heater that corresponds with a target flying height for the magnetic head from the calculated magnetic head flying height profile.

### BRIEF DESCRIPTION OF THE DRAWINGS

Exemplary embodiments of the inventive concept will be more clearly understood from the following detailed description taken in conjunction with the accompanying drawings in which:

FIG. 1 is a top view of a head disk assembly of a disk drive to which the inventive concept is applied;

FIG. 2 is a sectional view of a magnetic head for explaining a method of determining the position of a heater added to the magnetic head, and a graph illustrating a relationship between the position of the heater and the protrusion of an air bearing surface;

FIG. 3 is a block diagram illustrating an electric circuit of the disk drive to which the inventive concept is applied;

FIG. 4 is a block diagram of an apparatus for estimating a touch-down approach flying height according to an embodiment of the inventive concept;

FIG. 5 is a block diagram of an apparatus for estimating a touch-down approach flying height according to another embodiment of the inventive concept;

FIG. 6 is a block diagram of an apparatus for estimating a touch-down approach flying height according to another embodiment of the inventive concept;

FIG. 7 is a flowchart illustrating a method of controlling a flying height of a magnetic head according to an embodiment of the inventive concept;

FIG. 8 is a flowchart illustrating a method of estimating a touch-down approach flying height according to an embodiment of the inventive concept;

FIG. 9 is a flowchart illustrating a method of estimating a touch-down approach flying height according to another embodiment of the inventive concept;

FIG. 10A is a graph illustrating a signal reproduced at a normal flying height in a time domain;

FIG. 10B is a graph illustrating a signal reproduced at a touch-down approach flying height in a time domain;

FIG. 10C is a graph illustrating a signal that is reproduced at a touch-down approach flying height and is low-pass-filtered in a time domain;

FIG. 10D is a graph illustrating a signal that is reproduced at a touch-down approach flying height, is low-pass-filtered, and has no DC component in a time domain;

FIG. 11A is a graph illustrating a signal reproduced at a normal flying height in a frequency domain;

FIG. 11B is a graph illustrating a signal reproduced at a touch-down approach flying height in a frequency domain;

FIG. 11C is a graph illustrating a signal that is reproduced at a touch-down approach flying height and is low-pass-filtered in a frequency domain;

FIG. 11D is a graph illustrating a signal that is reproduced at a touch-down approach flying height, is low-pass-filtered, and is high-pass-filtered in a frequency domain;

FIGS. 12A through 12D are enlarged graphs illustrating FIGS. 11A through 11D, respectively;

FIG. 13A illustrates a frequency bandwidth of a low-pass-filter having a narrow bandwidth;

FIG. 13B illustrates a frequency bandwidth of a high-pass-filter having a narrow bandwidth;

FIG. 13C illustrates a frequency bandwidth of a low-pass-filter having a wide bandwidth;

FIG. 13D illustrates a frequency bandwidth of a high-pass-filter having a wide bandwidth;

FIG. 13E illustrates a frequency bandwidth generated by a serial connection between the low-pass-filter and the high-pass-filter having the narrow bandwidth; and

FIG. 13F illustrates a frequency bandwidth generated by a serial connection between the low-pass-filter and the high-pass-filter having the wide bandwidth.

### DESCRIPTION OF EMBODIMENTS

The inventive concept will now be described in some additional detail with reference to the accompanying drawings. However, the inventive concept may be variously embodied and should not be construed as being limited to only the illustrated embodiments.

A hard disk drive (HDD) generally comprises a head disk assembly (HDA) including mechanical components and electric circuits.

Figure (FIG.) 1 is a top view of an HDA 10 of an HDD to which the inventive concept may be applied. The HDA 10 comprises at least one magnetic disk 12 that is rotated by a spindle motor 14, and a transducer (not shown) located adjacent to a surface of the disk 12.

The transducer reads information on disk 12 by detecting a magnetic field on the disk 12. The transducer writes information to disk 12 by selectively magnetizing portions of the disk 12. Although the transducer is explained hereafter as a single unit here, it should be understood that the transducer may comprise a writer for magnetizing the disk 12 and a reader for detecting the magnetic field of the disk 12. The reader may be conventionally implemented using one or more magneto-resistive (MR) element(s).

The transducer may be integrated into a magnetic head 16. The magnetic head 16 has a structure which generates an air bearing surface between the transducer and the surface of the disk 12. The magnetic head 16 is incorporated with a head stack assembly (HSA) 22. The HSA 22 is attached to an actuator arm 24 that has a voice coil 26. The voice coil 26 is located adjacent to a magnetic assembly 28 to define a voice coil motor (VCM) 30. A current supplied to the voice coil 26 generates a torque for rotating the actuator arm 24 about a bearing assembly 32. The rotation of the actuator arm 24 causes the transducer to traverse the surface of the disk 12.

Information is typically stored in annular tracks 34 of the disk 12. Each of the tracks 34 generally includes a plurality of sectors. Each of the sectors includes a data field and a servo field. The servo field includes a preamble, a servo address/index mark (SAM/SIM), gray code, and burst signals A, B, C, and D. The transducer moves across the surface of the disk 12 to read or write information in other tracks.

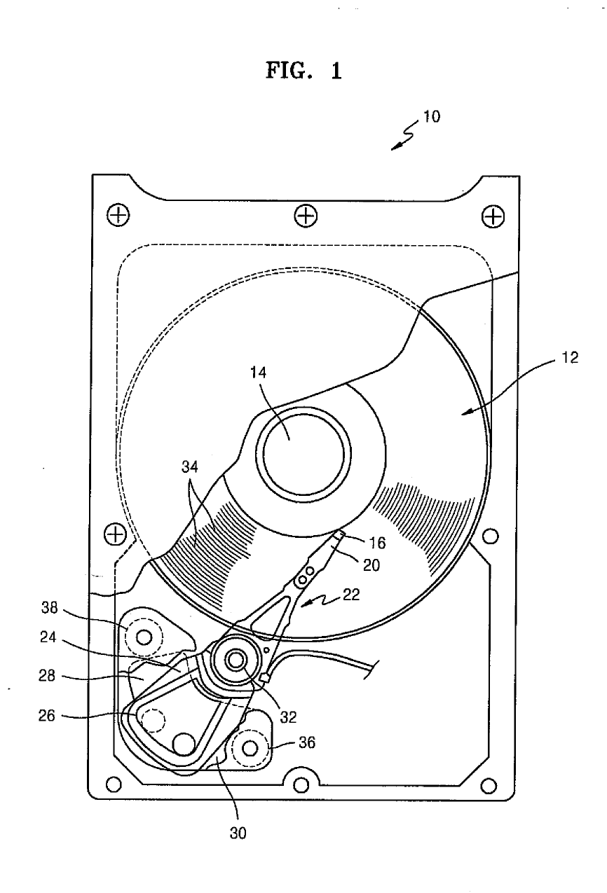

In the illustrated embodiment of FIG. 1, the magnetic head 16 is assumed to have a structure that generates the air bearing surface between the surface of the disk 12 and the reader and writer, and also includes a heater for heating the structure that generates the air bearing surface. The heater may include a coil.

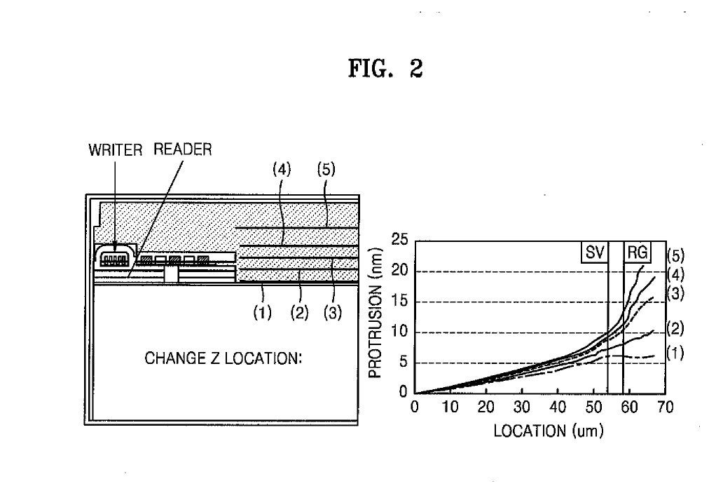

Referring to FIG. 2, the expansion of the air bearing surface of the magnetic head 16 is measured by supplying current to the coil of the heater while changing the location Z of the coil of the heater to determine the location of the coil of the heater where optimum expansion conditions are shown. In a graph shown in FIG. 2, the air bearing surface is relatively uniformly expanded in a location 1 between a reader position SV and a writer position RG.

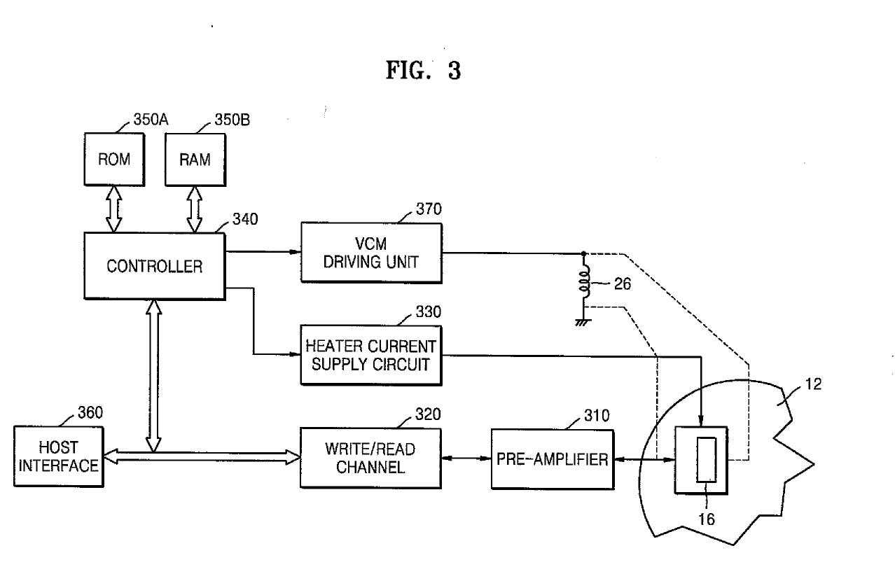

Referring to FIG. 3, the disk drive generally includes the disk 12, the magnetic head 16, a pre-amplifier 310, a write/read channel 320, a heater current supply circuit 330, a controller 340, a read-only memory (ROM) 350A, a random access memory (RAM) 350B, a host interface 360, a VCM driving unit 370.

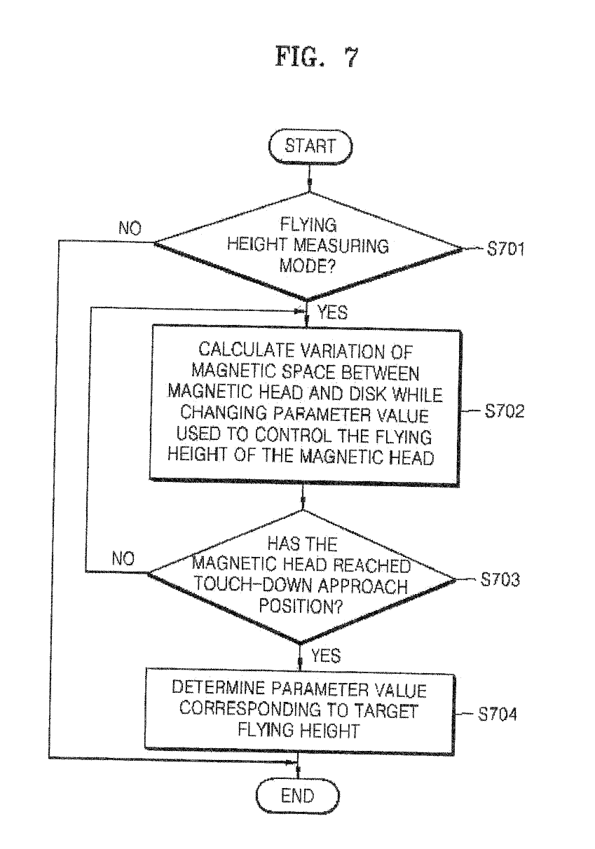

Firmware for controlling the disk drive and control information are stored in the ROM 350A. In particular, program codes and information consistent with the flowcharts of FIGS. 7-9 are stored therein. Information necessary for driving the disk drive, which is read from the ROM 350A or the disk 12 upon start-up of the disk drive, is stored in the RAM 350B.

The controller 340 analyzes a command received from a host device (not shown) via the host interface 360 and performs a control corresponding to the analyzed result. The controller 340 supplies a control signal to the VCM driving circuit 370 to control the excitation of the VCM and the movement of the magnetic head 16.

One possible mode of operation for the foregoing disk drive will now be explained with reference to FIGS. 1-3.

In a data read mode, the pre-amplifier 310 amplifies an electrical signal detected from the disk 12 by the reader of the magnetic head 16. Then, the write/read channel 320 amplifies the signal amplified by the pre-amplifier 310 to a predetermined level while an automatic gain control circuit (not shown) controls a gain, encodes the analogue signal amplified to the predetermined level by the automatic gain control circuit into a digital signal usable by the host device, converts the digital signal into stream data, and transmits the stream data to the host device via the host interface 360.

In a write mode, the write/read channel 320 converts data that is received from the host device via the host interface 360 into a binary data stream suitable for a write channel, the pre-amplifier 310 amplifies a write current, and the writer of the magnetic head 16 records the data using the amplified write current on the disk 12.

While reproducing the preamble, the servo address/index mark (SAM/SIM), the gray code, and the burst signals recorded in the servo field, the write/read channel 320 provides information necessary for the control of track-seek and track-following motions. In particular, the write/read channel 320 determines a servo gain value of the automatic gain control circuit using the preamble signal.

The heater current supply circuit 380 supplies current to the heater installed inside the magnetic head 16. Current supplied to the heater is determined according to a parameter value used to control a flying height of the magnetic head 16 applied from the controller 340.

The flying height of the magnetic head 16 needs to be precisely measured and controlled in magnetic head sets due to a deviation of component performance. Therefore, a parameter value used to control the flying height of the magnetic head 16 is determined in order to measure the flying height of the magnetic head 16 and operate the magnetic head 16 at a target flying height during a process of inspecting a hard disk drive (HDD).

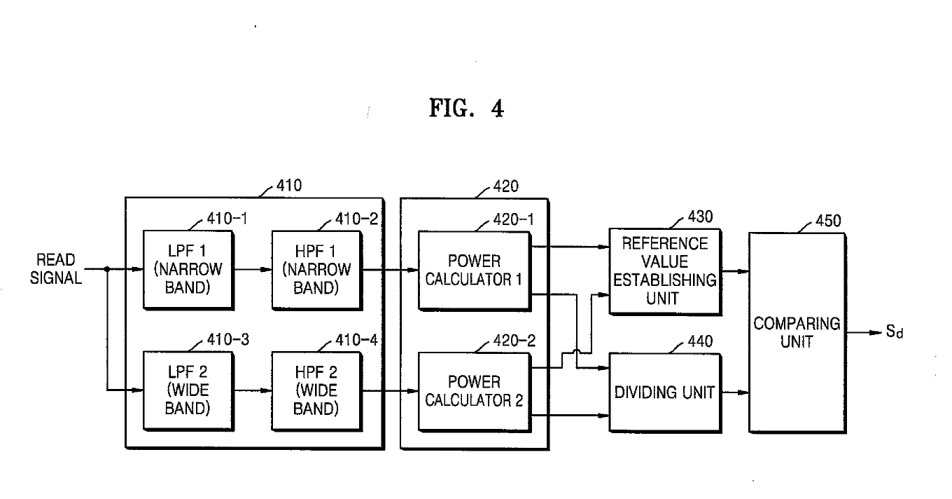

The controller 340 executes a control process for controlling the power supplied to the heater installed inside the magnetic head 16 in order to change the flying height measuring mode, calculate a magnetic head flying height profile indicating a change in the clearance between the magnetic head 16 and the disk 12 according to a change in the power supplied to the heater by using a determination result of an apparatus for determining a touch-down approach position shown in FIGS. 4-6, and determine the amount of power that should be supplied to the heater corresponding to the target flying height of the magnetic head 16 from the calculated magnetic head flying height profile.

One method of controlling the flying height of the magnetic head 16 under the control of the controller 340 is generally summarized by the flowchart of FIG. 7.

First, it is determined whether the drive is operating in a flying height measuring mode (S701). The flying height measuring mode may begin, for example, in an inspection process once the drive is assembled.

If the drive is operating in the flying height measuring mode (S701=yes), the device enters a test mode (S702). In this test mode, a test signal having a repetitive pattern of regular period is written to disk 12, a parameter value used to control the flying height of the magnetic head 16 is changed, a read operation is performed in an area in which the test signal is written, and a variation in the magnetic space between the magnetic head 16 and the disk 12 is calculated. The parameter for controlling the flying height of the magnetic head 16 is, for example, a parameter for determining the amount of power supplied to the heater of the magnetic head 16. The parameter value is changed to increase the power supplied to the heater by a predetermined amount from a power value allowing no head touch-down to occur. For example, the power value can be increased from 0 by the predetermined amount.

The resulting variation in the magnetic space between the magnetic head 16 and the disk 12 may be calculated, for example, by obtaining a profile of the flying height of the magnetic head 16 over the disk 12 with respect to a change in the power consumption of the heater using Wallace spacing loss equation by amplitude.

The Wallace spacing loss equation is defined according to equation below,

d=(λ/2π)*Ls, (1),

wherein, d=variation of magnetic space between disk and magnetic head, λ=recording wavelength=linear velocity/recording frequency, Ls=Ln (TAA1/TAA2), TAA1=previous AGC gain value, and TAA2=present AGC gain value.

Accordingly, the magnetic space between the disk 12 and the magnetic head 16 with regard to a change in the AGC gain value can be obtained using equation 1. Since the AGC gain values according to the variation of the power consumption of the heater can be measured, the variation of the magnetic space between the magnetic head 16 and the disk 12 with respect to the change in the power consumption of the heater can be obtained.

Next, it is determined whether the magnetic head 16 reaches a touch-down approach position above the disk 12 during the test mode (i.e., during the method step S702) (S703). Although conventional techniques may be used to determined whether a touch-down (i.e., physical contact between the head and the disk) has actually occurred, in the illustrated embodiment, it is determined whether the magnetic head 16 reaches a “touch-down approach position” over the disk 12 in order to prevent a disk scratch likely to be caused by an actual touch-down. Previously, the detection of a touch-down is required to calculate the flying height of the magnetic head 16 using the variation of the magnetic space between the magnetic head 16 and the disk 12 with respect to the change in the power consumption of the heater based on the disk surface. An apparatus and method for estimating a touch-down approach flying height for the magnetic head will be described in some additional detail with reference to FIGS. 4-6, 8, and 9.

After the magnetic head 16 reaches the touch-down approach position above the disk 12, a parameter value corresponding to a target flying height is determined from the profile of the flying height of the magnetic head 16 over the disk 12 with respect to the change in the power consumption of the heater (S704). In more detail, a power consumption value for the heater corresponding to the target flying height is obtained from the profile of the flying height of the magnetic head 16 over the disk 12 with respect to the change in the power consumption of the heater, based on the power consumption of the heater at a time when the magnetic head 16 reaches the touch-down approach position of the disk 12. Thereafter, if the parameter value is determined to obtain the power consumption value of the heater, the parameter value will correspond to the target flying height thus obtained.

One possible method for estimating a touch-down approach flying height of a magnetic head of the present invention will be described.

A test signal having a regular period is written to the disk 12, and the touch-down approach flying height is estimated while an area in which the test signal is written is reproduced. If the test signal is reproduced at a normal flying height other than the touch-down approach flying height, a distortion does not ideally occur and thus the test signal is reproduced as a sine wave having a regular amplitude. The test signal reproduced at the normal flying height is s_HF(t) according to equation below,

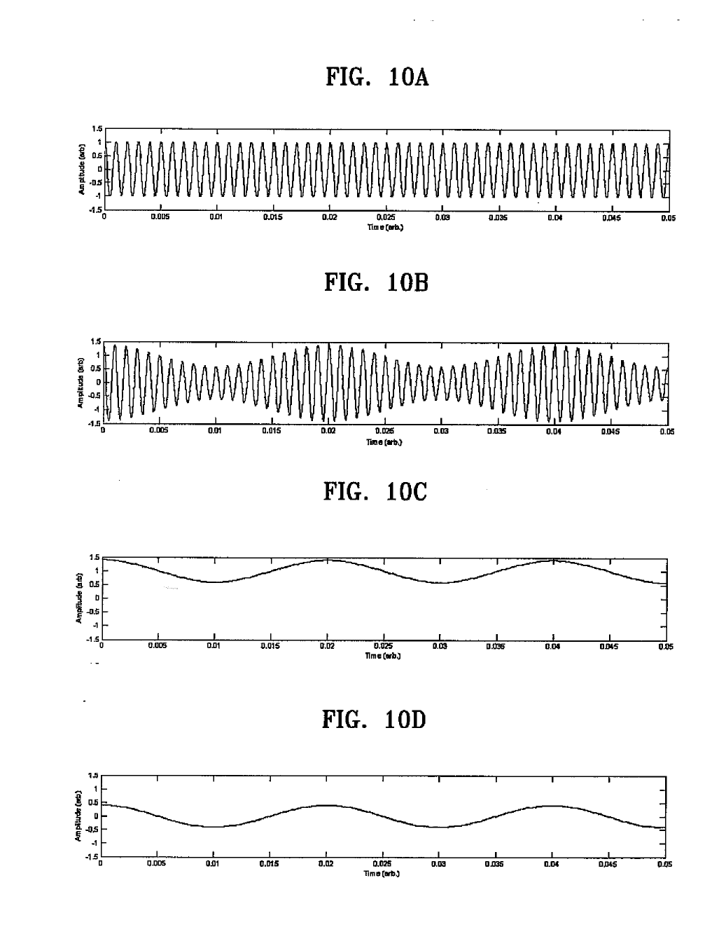

s_{HF}(t)=α cos(2πf_{HF}t+α) (2)

wherein, a>0, f_{HF}=frequency component of original signal, α=phase of S_{HF}, and s_HF(t) of a time domain is shown in FIG. 10A.

A distortion occurs in the test signal reproduced when the magnetic head 16 reaches the touch-down approach position of the disk 12 shown in FIG. 10B. The distortion has a waveform including a low frequency component.

The test signal reproduced in the touch-down approach position is s_TD(t) according to equation below,

s_{TD}(t)=α cos(2πf_{HF}t+α){b cos(2πf_{LF}t+β)+c} (3)

wherein, b>0, f_{LF}=frequency component occurred when approach the touch-down, β=phase of the signal reproduced when approach the touch-down, and c is a constant.

Equation 3 shows that a signal having a high frequency component HF is modulated from a specific signal having a low frequency component LF. An amplitude change in the signal reproduced in the touch-down approach position is defined according to equation below,

−ab−c≦s_{TD}(t)≦ab+c (4)

If the specific signal having the low frequency component LF of the signal reproduced in the touch-down approach position is s_LF(t), s_LF(t) can be separated from equation 3 and is defined according to equation below,

s_{LF}(t)=b cos(2πf_{LF}t+β) (5),

wherein b>0, f_{LF}=frequency component occurred when approach the touch-down, β=phase of S_{LF}, s_LF(t) in a time domain is shown in FIG. 10C, and s_LR(t) from which a DC component is removed in FIG. 10C is shown in FIG. 10D.

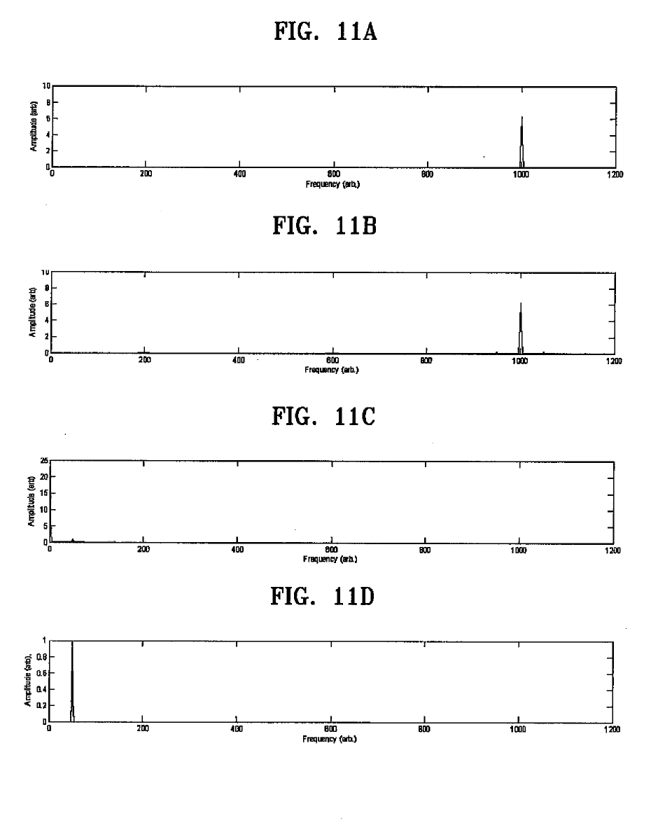

The signal reproduced at the normal flying height and the signal reproduced in the touch-down approach flying height position in a frequency domain are shown in FIGS. 11A and 11B, respectively.

In more detail, FIG. 11A shows the frequency characteristics of the signal reproduced at the normal flying height, and FIG. 11B shows the frequency characteristics of the signal reproduced at the touch-down approach flying height.

FIG. 11C shows the frequency characteristics of the signal reproduced at the normal flying height after the signal is low-pass-filtered. FIG. 11D shows the frequency characteristics of the signal that reproduced in the touch-down approach flying height position, low-pass-filtered, and has no DC component.

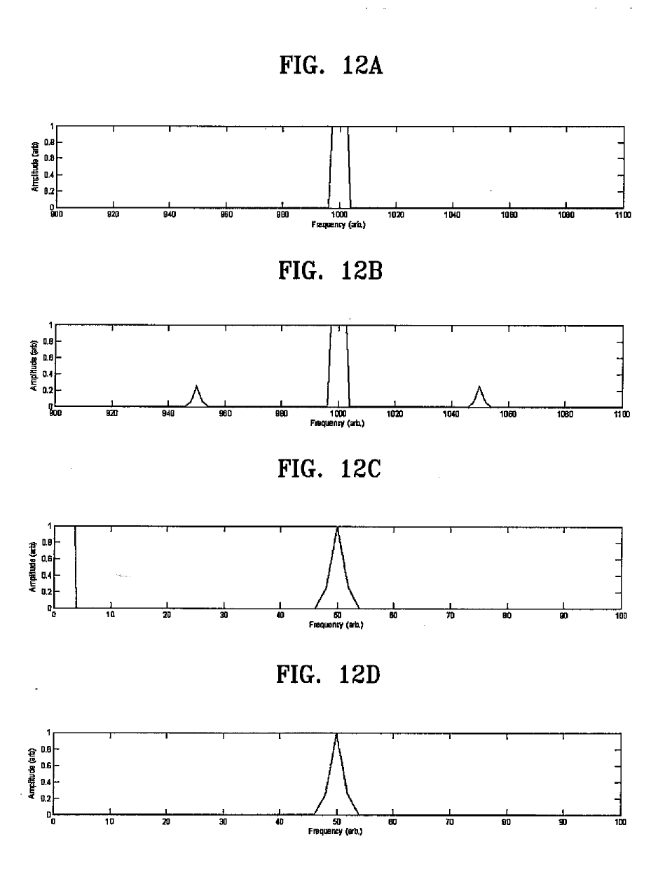

FIGS. 12A through 12D are enlarged views of the FIGS. 11A through 11D, respectively. When the area in which the test signal is written is reproduced at the normal flying height, since the written test signal has a regular period, the test signal has a regular high frequency component as shown in FIG. 11A.

The signal reproduced at the normal flying height is S_HF(f) according to equation below,

|S_{HF}(f)|=A(δ(f+f_{HF})+δ(f−f_{HF})) (6)

wherein, A>0.

The signal reproduced in the touch-down approach flying height position has a low frequency component quite lower than an original signal as shown in FIG. 12B.

The signal reproduced in the touch-down approach flying height position is S_TD(f) according to equation below,

|S_{TD}(f)|=|S_{HF}(f)|+B{δ(f+f_{HF}+f_{LF})+δ(f+f_{MF}−f_{LF})+δ(f−f_{HF}+f_{LF})+δ(f−f_{LF}−f_{LF})} (7)

wherein, B>0.

Equation 7 shows that the signal having the high frequency HF component is modulated from the signal having the low frequency LF component in the same manner as described with regard to the time domain.

Therefore, when the signal having the low frequency LF component generated when reproduced in the touch-down approach flying height position is S_LF(f), S_LF(f) that is low-pass-filtered for its separation is shown in FIG. 12C. Referring to FIG. 12C, S_LF(f) having a DC component is high-pass-filtered in order to remove the DC component from S_LF(f) so that a component S_LF(f) can be detected. The detected component S_LF(f) is defined according to equation below,

|S_{LF}(f)|=B′{δ(f+f_{LF})+δ(f−f_{LF})} (8)

wherein, B′>0.

When a value B′ is greater than a specific reference value, it is determined that the flying height of the magnetic head 16 reaches the touch-down approach position.

Therefore, it is possible to detect a status of the flying height of the magnetic head 16 that reaches the touch-down approach position immediately before the touch-down actually occurs.

An apparatus and method for detecting the status of the flying height of the magnetic head 16 that reaches the touch-down approach position from a HDD by using the method of estimating a touch-down approach flying height will now be described.

An apparatus for estimating the touch-down approach flying height will now be described with reference to FIG. 4. FIG. 4 is a block diagram of the apparatus for estimating the touch-down approach flying height according to an embodiment of the inventive concept. Circuit units shown in FIG. 4 can be included in the write/read channel 320 in the circuit of the HDD shown in FIG. 3, and can be included in the pre-amplifier 310.

Referring to FIG. 4, the apparatus for estimating the touch-down approach flying height comprises a filtering unit 410, a power calculating unit 420, a reference value establishing unit 430, a dividing unit 440, and a comparing unit 450.

In the illustrated embodiment, the filtering unit 410 comprises a low-pass-filter 1 (LPF1) 410-1 having a narrow bandwidth, a high-pass-filter 1 (HPF1) 410-2 having the narrow bandwidth, an LPF2 410-3 having a wide bandwidth, and an HPF2 410-4 having the wide bandwidth. The power calculating unit 420 comprises a power calculator 1 420-1 and a power calculator 2 420-2.

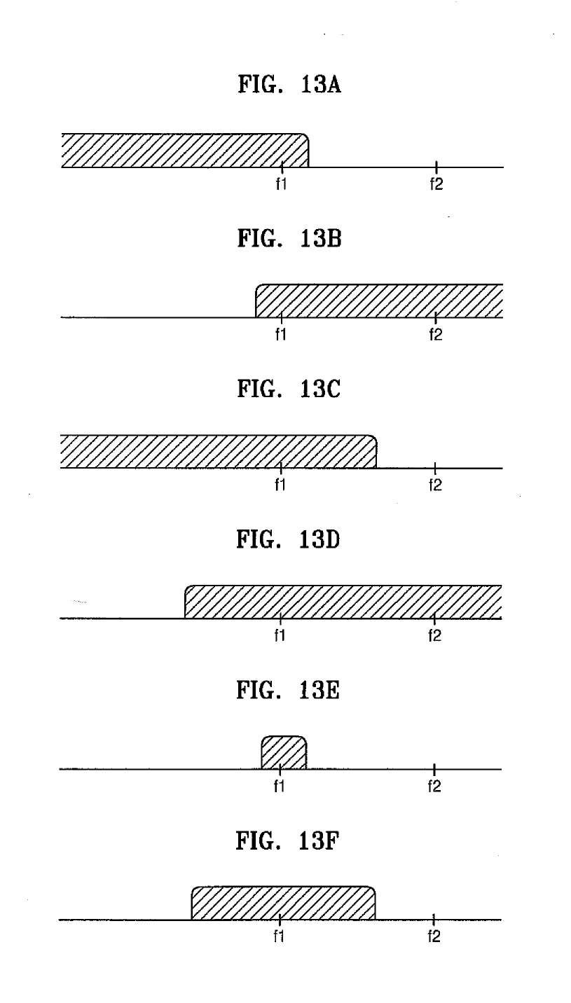

A frequency bandwidth established for the LPF1 410-1 is shown in FIG. 13A. A frequency bandwidth established for the HPF1 410-2 is shown in FIG. 13B. A frequency bandwidth established for the LPF3 410-2 is shown in FIG. 13C. A frequency bandwidth established for the HPF4 410-24 is shown in FIG. 13D. A frequency f1 shown in FIGS. 13A through 13F is a distortion frequency component of a signal reproduced when a touch-down is approached, and a frequency f2 is a frequency component of a reproduced original signal.

The filtering unit 410 has a structure in which the LPF1 410-1 and the HPF1 410-2 having the relatively narrow bandwidth are connected in series, and the LPF2 410-3 and the HPF2 410-4 having the relatively wide bandwidth are connected in series.

Therefore, the frequency band characteristics of the series connected LPF1 410-1 and HPF1 410-2 are shown in FIG. 13E, and the frequency band characteristics of the series connected LPF2 410-3 and HPF2 410-4 are shown in FIG. 13F.

The filtering unit 410 inputs a signal reproduced in a test area of a disk in which a signal having a test pattern of regular period is written, and filters/outputs a signal component in a first frequency band of a narrow band including the frequency component f1 in which a distortion occurrence is predicted when the touch-down is approached and a signal component in a second frequency band of a wide band including the first frequency band.

Referring to FIGS. 13A through 13F, the frequency component f1 in which the distortion occurrence is predicted when an approaching touch-down is established to be included in a bandwidth of each filter included in the filtering unit 410.

The frequency component f2 of the original signal of each test pattern is defined in such a manner so as to not be included in the frequency band of the series connected the LPF1 410-1 and HPF1 410-2 and the frequency band of the series connected the LPF2 410-3 and HPF2 410-4.

For reference, since it is necessary to vary the band pass characteristics according to the intrinsic characteristics of the HDD, such as a data rate, a rotational speed of the disk, etc., each filter of the filtering unit 410 will be programmed in its operative nature.

The power calculator 1 420-1 calculates a first power value P_NB of the signal component in the first frequency band of the narrow band that passes the LPF1 410-1 and the HPF1 410-2 having the narrow bandwidth of the filtering unit 410.

The power calculator 2 420-2 calculates a second power value P_WB of the signal component in the second frequency band of the wide band that passes the LPF2 410-3 and the HPF2 410-4 having the wide bandwidth of the filtering unit 410.

The reference value establishing unit 430 establishes a value, as a reference value, obtained by adding a margin value to a value obtained by dividing the first power value P_NB by the second power value P_WB calculated in a normal status in which the magnetic head does not reach the touch-down approach flying height. The second power value P_WB calculated in the normal status in which the magnetic head does not reach the touch-down approach flying height is a power value with regard to total noise of a wide band that does not include a component of a reproduced original signal. The first power value P_NB calculated in the normal status in which the magnetic head does not reach the touch-down approach flying height is a power value with regard to total noise of a narrow band that does not include the component of the reproduced original signal.

The margin value is determined according to the detection characteristics of the touch-down approach flying height based on statistical data. The reference value of the present embodiment is not limited thereof but can be established using a variety of methods. In more detail, the reference value establishing unit 430 reproduces a signal at a reliable flying height that is regarded as the normal status in which the magnetic head does not reach the touch-down approach flying height, establishes the reference value, and sends the established reference value to the comparing unit 450.

The dividing unit 440 divides the first power value P_NB by the second power value P_WB that are calculated by the power calculating unit 420 and sends the calculation result to the comparing unit 450.

The comparing unit 450 compares the reference value established by the reference value establishing unit 430 with the value obtained by the dividing unit 440, if the value obtained by the dividing unit 440 is smaller than or the same as the reference value, it is determined as a normal flying height, and if the value obtained by the dividing unit 440 is greater than the reference value, generates a signal Sd indicating that it is determined that the magnetic head reaches the touch-down approach flying height.

For reference, at the normal flying height, the second power value P_WB is the power value with regard to total noise of the wide band that does not include the component of the reproduced original signal, and the first power value P_NB is the power value with regard to total noise of the narrow band that does not include the component of the reproduced original signal, so that the value obtained by the dividing unit 440 cannot exceed the reference value.

Meanwhile, in a status that the magnetic head reaches the touch-down approach flying height, the second power value P_WB is a power value with regard to total noise of a wide band having a low frequency signal component that distorts the reproduced original signal, and the first power value P_NB is a power value with regard to total noise of a narrow band having the low frequency signal component that distorts the reproduced original signal, so that the portion of the first power value P_NB increases with regard to the second power value P_WB and thus the value obtained by the dividing unit 440 exceeds the reference value.

The above operation is repeated until the signal Sd indicating that it is determined that the magnetic head reaches the touch-down approach flying height while a sequential reduction in the flying height, which is a clearance between the magnetic head and the disk, of the magnetic head is controlled.

Referring to FIG. 3, the controller 340 controls the value of the parameter for determining the amount of the power supplied to the heater inside the magnetic head 16 to change the flying height of the magnetic head 16. In more detail, the controller 340 controls the value of the parameter to sequentially increase the amount of the power supplied to the heater inside the magnetic head 16 in order to sequentially control the flying height of the magnetic head 16.

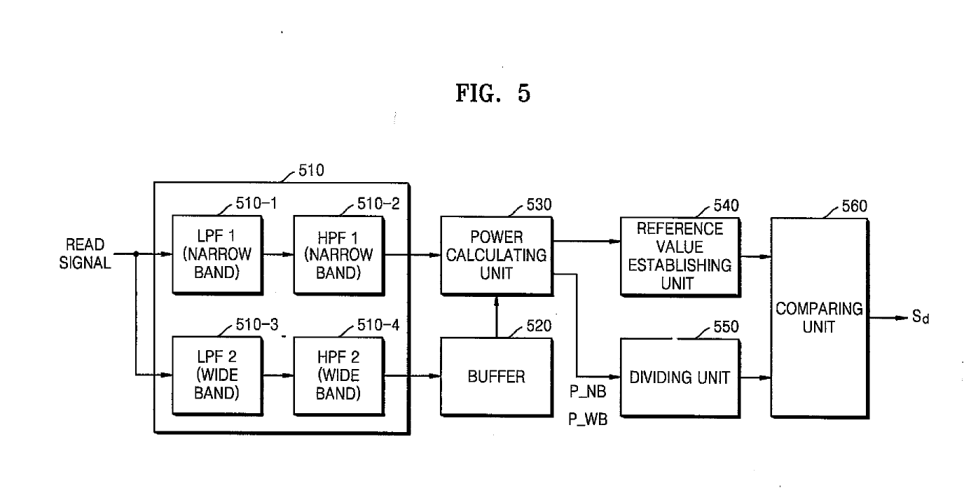

FIG. 5 is a block diagram of an apparatus for estimating a touch-down approach flying height according to another embodiment of the inventive concept. Circuit units shown in FIG. 5 can be included in the write/read channel 320 in the circuit of the HDD shown in FIG. 3, and can be included in the pre-amplifier 310.

Referring to FIG. 5, the apparatus for estimating the touch-down approach flying height comprises a filtering unit 510, a buffer 520, a power calculating unit 530, a reference value establishing unit 540, a dividing unit 550, and a comparing unit 560.

In the previous embodiment shown in FIG. 4, the apparatus for estimating the touch-down approach flying height comprises two power calculators 1 and 2 420-1 and 420-2 for calculating the first power value P_NB of the signal component in the first frequency band of the narrow band and the second power value P_WB of the signal component in the second frequency band of the wide band, respectively.

In the illustrated embodiment, the apparatus for estimating the touch-down approach flying height comprises the power calculating unit 530 including a power calculator for calculating the first power value P_NB and the second power value P_WB.

In more detail, the power calculating unit 530 calculates the first power value P_NB of a signal in a first frequency band of a narrow band that passes a LPF1 510-1 and a HPF1 510-2 that have a narrow bandwidth. While calculating the amount of power of the signal in the first frequency band of the narrow band, the power calculating unit 530 stores a signal in a second frequency band in a wideband that passes a LPF2 510-3 and a HPF2 510-4 in the buffer 520.

After completely calculating the first power value P_NB with regard to the signal in the first frequency band, the power calculating unit 530 reads the signal in the second frequency band stored in the buffer 520, and calculates the second power value P_WB with regard to the signal in the second frequency band.

In more detail, in the previous embodiment shown in FIG. 4, two power calculators are used to simultaneously calculate the first power value P_NB and the second power value P_WB, whereas, in the present embodiment, a power calculator is used to sequentially calculate the first power value P_NB and the second power value P_WB. The other elements are the same as those shown in FIG. 4 and thus the description thereof is not repeated.

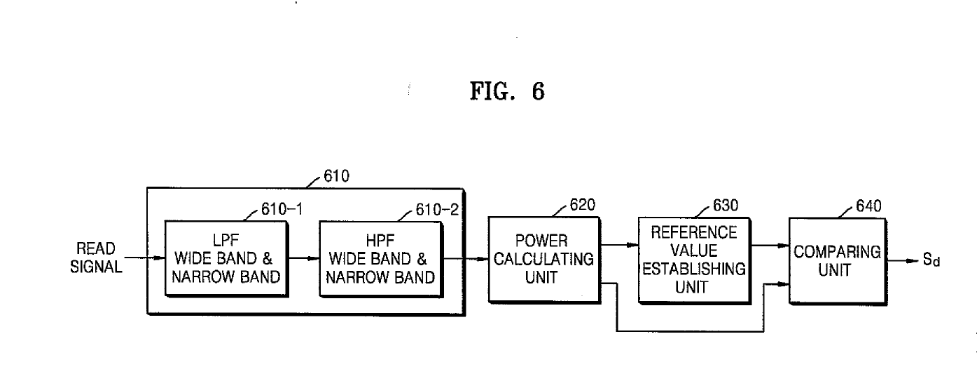

FIG. 6 is a block diagram of an apparatus for estimating a touch-down approach flying height according to another embodiment of the inventive concept. Circuit units shown in FIG. 6 can be included in the write/read channel 320 in the circuit of the HDD shown in FIG. 3, and can be included in the pre-amplifier 310.

Referring to FIG. 6, the apparatus for estimating the touch-down approach flying height comprises a filtering unit 610, a power calculating unit 620, a reference value establishing unit 630, and a comparing unit 640.

In more detail, the filtering unit 610 has a circuit structure in which a programmable LPF 610-1 and a programmable HPF 610-2 are connected in series.

The LPF 610-1 and HPF 610-2 are programmed to have a wide bandwidth during a section in which a reference value is established, and a narrow bandwidth during other sections. The section in which the reference value is established is selected from sections in which a signal is reproduced at a reliable flying height that is regarded as a normal status in which the magnetic head does not reach a touch-down approach flying height.

Therefore, during the section in which the reference value is established, the power calculating unit 620 calculates the second power value P_WB that is a power value of a signal component in a second frequency band of a wide band and sends the second power value P_WB to the reference value establishing unit 630.

The reference value establishing unit 630 adds a margin value to the second power value P_WB calculated during the section in which the reference value is established and calculates the reference value. The margin value is determined according to the detection characteristics of the touch-down approach flying height based on statistical data. The reference value is not limited to only the illustrated embodiment but may be established using a variety of methods.

After the section in which the reference value is established, the LPF 610-1 and HPF 610-2 are established to have the narrow bandwidth.

Therefore, after the section in which the reference value is established, the power calculating unit 620 calculates the first power value P_NB that is a power value of a signal component in a first frequency band of a narrow band and sends the first power value P_NB to the comparing unit 640.

The comparing unit 640 compares the reference value established by the reference value establishing unit 630 with the first power value P_NB calculated by the power calculating unit 620, if the first power value P_NB is smaller than or the same as the reference value, it is determined as a normal flying height, and if the first power value P_NB is greater than the reference value, generates a signal Sd indicating that it is determined that the magnetic head reaches the touch-down approach flying height.

For reference, the second power value P_WB calculated in a normal status in which the magnetic head reaches the touch-down approach flying height is a power value with regard to total noise of a wide band that does not include a component of a reproduced original signal, and the first power value P_NB calculated in a normal status in which the magnetic head reaches the touch-down approach flying height is a power value with regard to total noise of a narrow band that does not include the component of the reproduced original signal.

For reference, at the normal flying height, the second power value P_WB is a power value with regard to the total noise of the wide band that does not include the component of the reproduced original signal, and the first power value P_NB is a power value with regard to the total noise of the narrow band that does not include the component of the reproduced original signal, so that the first power value P_NB cannot exceed the reference value.

Meanwhile, in a status that the magnetic head reaches the touch-down approach flying height, the first power value P_NB is a power value with regard to total noise of a narrow band having a low frequency signal component that distorts the reproduced original signal, so that the first power value P_NB remarkably increases compared to that at the normal flying height, and thus the first power value P_NB exceeds the reference value.

The above operation is repeated until the signal Sd indicating that it is determined the magnetic head reaches the touch-down approach flying height while a sequential reduction in the flying height, which is a clearance between the magnetic head and the disk, of the magnetic head is controlled.

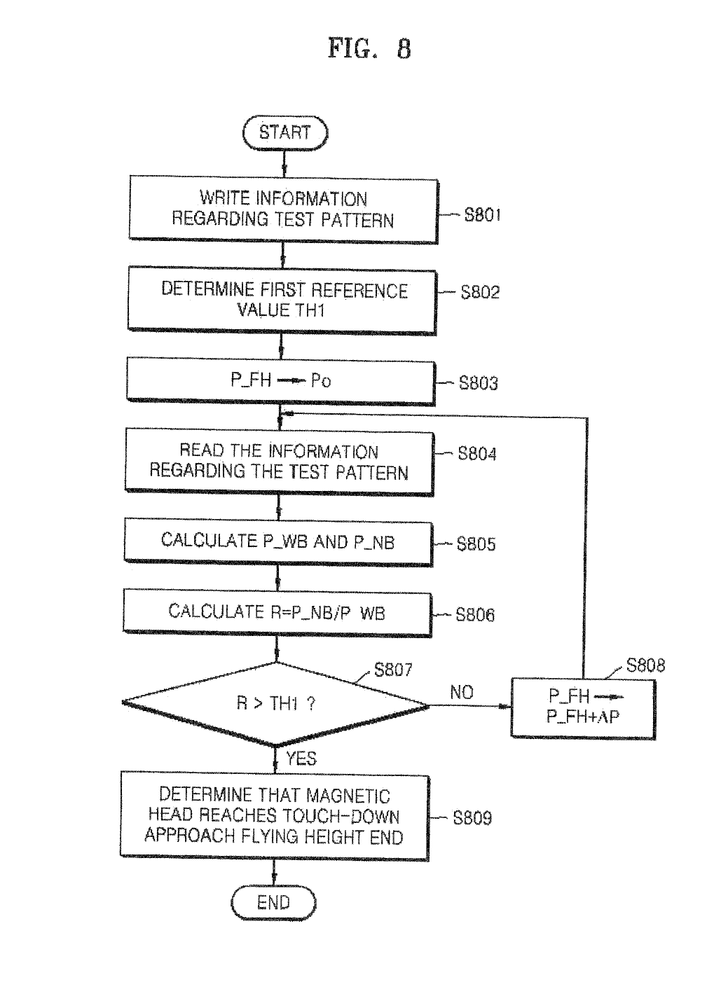

A method of estimating a touch-down approach flying height according to an embodiment of the inventive concept will now be described with reference to FIG. 8.

First, test pattern information having a regular period is written on a specific area of a disk (S801).

Then, a first reference value TH1 used to determine a touch-down approach flying height is determined (S802). The first reference value TH1 is determined by adding a margin value to a value obtained by dividing a first power value P_NB by a second power value P_WB calculated in a normal status in which the magnetic head does not reach the touch-down approach flying height. The first power value P_NB is a power value measured in a first frequency band of a narrow band including a frequency component in which a distortion occurrence is predicted when a touch-down is approached. The second power value P_WB is a power value measured in a second frequency band in a wide band including the first frequency band. The first and second frequency bands are established not to include a frequency component in a test pattern written on the disk.

After the first reference value TH1 is established, in operation 803, a value of power P_FH supplied to a heater inside in the magnetic head 16, which is used to control the flying height of the magnetic head 16, is established as an initial power value Po. The initial power value P is established to sufficiently guarantee a normal flying status. For example, the initial power value P can be established as 0.

Then, a process for reading the test pattern information from the disk 12 is performed (S804).

The first power value P_NB in the first frequency band of the narrow band and the second power value P_WB in the second frequency band in the wide band are calculated from a signal reproduced while the test pattern information is read (S805). For reference, the first power value P_NB and the second power value P_WB can be calculated using the filtering units and the power calculating units shown in FIGS. 4 and 5.

The first power value P_NB is then divided by the second power value P_WB and a dividing value R is obtained (S806).

Then the dividing value R is compared with the first reference value TH1 (S807).

If the dividing value R is less than or equal to the first reference value TH1 (S807=no), then the power value P_FH for controlling the flying height of the magnetic head 16 is increased by ΔP (S808), and the method repeats S804 through S807.

However, if the dividing value R is greater than the first reference value TH1 (S807=yes), then a signal indicating that it is determined that the magnetic head reaches the touch-down approach flying height is generated (S809).

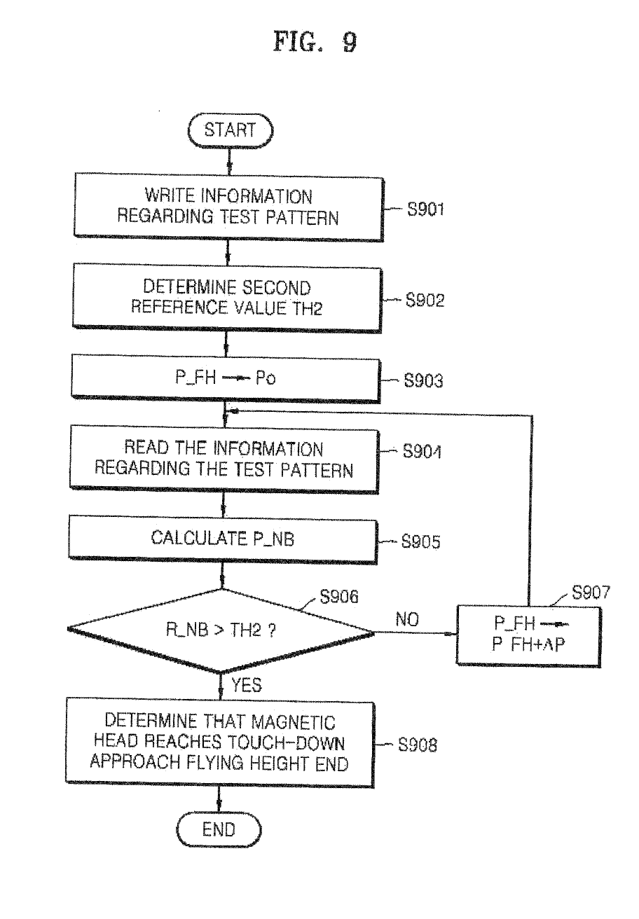

A method of estimating a touch-down approach flying height according to another embodiment of the inventive concept will now be described with reference to FIG. 9.

First, test pattern information having a regular period is written on a specific area of a disk (S901).

The second reference value TH2 used to determine a touch-down approach flying height is determined (S902). The second reference value TH2 is determined by adding a margin value to a second power value P_WB calculated from a signal reproduced in a normal status in which the magnetic head does not reach the touch-down approach flying height.

The second power value P_WB is a power value measured in a second frequency band in a wide band including a frequency band in which a distortion occurrence is predicted. In particular, the second frequency band is established not to include a frequency component in a test pattern written on the disk.

After the second reference value TH2 is established, a value of power P_FH supplied to a heater inside in the magnetic head 16, which is used to control the flying height of the magnetic head 16, is established as an initial power value Po. The initial power value P is established to sufficiently guarantee a normal flying status. For example, the initial power value P can be established as 0.

Then, a process for reading the test pattern information from the disk 12 is performed (S904).

A first power value P_NB in the narrow band is calculated from a signal reproduced while the test pattern information is read (S905). The first power value P_NB is a power value calculated in a first frequency band of a narrow band including the frequency component in which the distortion occurrence is predicted when a touch-down is approached. The second power value P_WB is a power value calculated in a second frequency band in a wide band including the first frequency band.

Then the first power value P_NB is compared with the second reference value TH2 (S906).

If the first power value P_NB is less than or equal to the second reference value TH2 (S906=no), a power value P_FH for controlling the flying height of the magnetic head 16 is increased by ΔP (S907), and operations 904 through 906 are repeated.

However, if the second reference value TH2 is greater than the second reference value TH2 (S906=yes), a signal indicating that it is determined that the magnetic head reaches the touch-down approach flying height is generated (S908).

The above methods and apparatuses can detect a status in which a magnetic head reaches a touch-down approach flying height immediately before a touch-down actually occurs in order to measure and control the flying height of a magnetic head.

While the inventive concept has been particularly shown and described with reference to exemplary embodiments thereof, it will be understood that various changes in form and details may be made therein without departing from the scope of the following claims.

What is claimed is:

1. A method of estimating a touch-down approach flying height, the method comprising:
writing information regarding a test pattern on a disk;
reproducing a test pattern signal in an area in which the information regarding the test pattern is written while changing a value of a parameter used to control a flying height of a magnetic head;
measuring a first power value in a first relatively narrow frequency band including a frequency component such that a distortion occurrence predicts an approaching touch-down, and a second power value in a relatively wide second frequency band including the first frequency band;
determining if the first power value compared to the second power value satisfies a critical condition; and
if the first power value compared to the second power value satisfies the critical condition, determining that the magnetic head has reached the touch-down approach flying height.

2. The method of claim 1, wherein the parameter is used to determine an amount of power supplied to a heater heating the magnetic head.

3. The method of claim 2, wherein the value of the parameter is changed to sequentially increase the amount of power supplied to the heater until the magnetic head reaches the touch-down approach flying height.

4. The method of claim 1, wherein the first frequency band and the second frequency band do not include a frequency component characterizing the test pattern.

5. The method of claim 1, wherein the critical condition is met when a value defined by dividing the first power value by the second power value exceeds a first reference value.

6. The method of claim 5, wherein the first reference value is further obtained by adding a first margin value during a normal status in which the magnetic head has not reached the touch-down approach flying height by the second power value.

7. The method of claim 1, wherein the critical condition is met when the first power value exceeds a second reference value determined in relation to the second power value.

8. The method of claim 8, wherein the second reference value is determined by adding a second margin value to a second power value measured in a normal status in which the magnetic head has not reached the touch-down approach flying height.

9. A method of controlling a flying height, the method comprising:
calculating variation of a magnetic space between a magnetic head and a disk according to a change in a value of a parameter while changing the value of the parameter used to control a flying height of the magnetic head in a mode during which a test signal containing information related to a test pattern is reproduced;
determining if the flying height of the magnetic head reaches a touch-down approach position; and
determining a parameter value corresponding to a target flying height based on the variation of the magnetic space between the magnetic head and the disk calculated according to a parameter value when the flying height of the magnetic head reaches the touch-down approach position.

10. The method of claim 9, wherein determining if the flying height of the magnetic head reaches the touch-down approach position comprises:
measuring a first power value in a first relatively narrow frequency band including a frequency component such that a distortion occurrence predicts when a touch-down is approached, and a second power value in a relatively wide second frequency band including the first frequency band;
determining if the first power value compared to the second power value satisfies a critical condition; and
if the first power value compared to the second power value is determined to satisfy the critical condition, determining that the magnetic head has reached the touch-down approach flying height.

11. The method of claim 10, wherein the first frequency band and the second frequency band are established not to include a frequency component characterizing the test pattern.

12. The method of claim 10, wherein the critical condition is met when a value obtained by dividing the first power value by the second power value exceeds a first reference value determined by adding a first margin value to a value obtained by dividing a first power value measured in a normal status in which the magnetic head has not reached the touch-down approach flying height by the second power value.

13. The method of claim 10, wherein the critical condition is met when the first power value exceeds a second reference value determined by adding a second margin value to the second power value measured in the normal status in which the magnetic head has not reached the touch-down approach flying height.

14. An apparatus for estimating a touch-down approach flying height, the apparatus comprising:
a filtering unit filtering and outputting a signal in a first relatively narrow frequency band including a frequency component in which a distortion occurrence is predicted when a touch-down is approached, and a signal in a second relatively wide frequency band including the first frequency band by inputting a test signal reproduced from a disk having information regarding a test pattern written thereon while controlling a flying height of a magnetic head;
a power calculating unit calculating a first power value in relation to the signal in the first frequency band and a second power value related to the signal in the second frequency band;
a dividing unit calculating a dividing value obtained by dividing the first power value by the second power value; and
a comparing unit comparing the dividing value and a first reference value, and
if the dividing value exceeds the first reference value, generating a signal indicating that the magnetic head has reached the touch-down approach flying height.

15. The apparatus of claim 14, wherein the first reference value is determined by adding a first margin value to a value obtained by dividing a first power value measured in a normal status in which the magnetic head has not reached the touch-down approach flying height by a second power value.

16. The apparatus of claim 14, wherein the filtering unit comprises:
a first low-pass-filter passing a low frequency signal in the relatively narrow band including the frequency component in which the distortion occurrence is predicted when touch-down is approached by inputting the signal reproduced in the disk;
a first high-pass-filter connected in serial to the first low-pass-filter, and passing a high frequency signal in the relatively narrow band including the frequency component in which the distortion occurrence is predicted when touch-down is approached;
a second low-pass-filter passing a low frequency signal in the relatively wide band including the frequency component in which the distortion occurrence is predicted when the touch-down is approached by inputting the signal reproduced in the disk; and
a second high-pass-filter connected in serial to the second low-pass-filter, and passing a high frequency signal in the relatively wide band including the frequency component in which the distortion occurrence is predicted when the touch-down is approached.

17. The apparatus of claim 14, wherein the power calculating unit comprises:
a buffer temporarily storing the signal in the first frequency band or the signal in the second frequency band; and
a power calculating unit calculating the amount of power of a selected input signal by selectively inputting one of the signal in the first frequency band or the signal in the second frequency band that is not stored in the buffer.

18. An apparatus for estimating a touch-down approaching flying height, the apparatus comprising:
a filtering unit selectively filtering a read data signal and outputting either a first signal in a first, narrow-band, frequency band including a frequency component corresponding to a predicted distortion occurrence related to an approaching touch-down, or a second signal in a second, wide-band, frequency band including the first, narrow-band, frequency band, wherein the read data signal is derived by reproducing data stored on a disk and including test pattern information while controlling a flying height of a magnetic head associated with the disk;
a power calculating unit calculating a first power value in relation to the first signal or a second power value in relation to the second signal; and
a comparing unit comparing the first power value and a reference value determined in relation to the second power value as calculated during a normal operating status for the magnetic head wherein the touch-down approaching flying height is not reached, and upon determining that the first power value exceeds the reference value, generating a signal indicating that the magnetic head has reached the touch-down approaching flying height.

19. The apparatus of claim 18, wherein the filtering unit comprises:
a programmable low-pass-filter selectively passing a low frequency signal in the first, narrow-band, frequency band or in the second, wide-band frequency band, wherein the low frequency signal includes the frequency component corresponding to the predicted distortion occurrence related to an approaching touch-down; and
a programmable high-pass-filter serially connected to the programmable low-pass-filter and passing a high frequency signal in the first, narrow-band frequency band or in the second, wide-band frequency band, wherein the high frequency signal includes the frequency component corresponding to a predicted distortion occurrence related to an approaching touch-down,
wherein the respective frequency bands of the programmable low-pass-filter and programmable high-pass-filter are established as the second, wide-band frequency band during a reference value establishing mode, and
following the reference value establishing mode, the respective frequency bands of the programmable low-pass-filter and programmable high-pass-filter are established as the first, narrow-band, frequency band.

20. A disk drive comprising:
a disk storing information;
a magnetic head including a magnetic read element detecting a magnetic field on the disk and a magnetic write element magnetizing the disk, a structure generating an air bearing between a surface of the disk and the magnetic head, and a heater heating the magnetic head to generate the air bearing;
a touch-down approach position determining unit determining whether a flying height of the magnetic head has reached a touch-down approach position over the disk based on a power value associated with at least one frequency band related to a test signal reproduced from information regarding a test pattern recorded on the disk; and
a controller calculating a magnetic head flying height profile indicating a change in clearance between the magnetic head and the disk in relation to a change in power supplied to the heater and a determination result received from the touch-down approach position determining unit changing the power supplied to the heater, and determining an amount of power supplied to the heater that corresponds with a target flying height for the magnetic head from the calculated magnetic head flying height profile.
